(19) United States
(12) Patent Application Publication
(10) Pub. No.: US 2025/0147196 A1
(43) Pub. Date: May 8, 2025

(54) SEISMIC CONE PENETRATION TEST TOOLS AND SYSTEMS INCLUDING THE SAME

(71) Applicant: OCEAN INFINITY OPERATIONS PTE. LTD., 15 Scotts (SG)

(72) Inventors: Adrian Woodroffe, Nelson (CA); Melanie Devaux, Richmond (CA); Luke Alden, Vancouver (CA); Naman Rastogi, Surrey (CA)

(21) Appl. No.: 18/691,328

(22) PCT Filed: Sep. 13, 2022
(86) PCT No.: PCT/EP2022/075463

§ 371 Date: Mar. 12, 2024

Related U.S. Application Data
(60) Provisional application No. 63/399,120, filed on Aug. 18, 2022.
(60) Provisional application No. 63/243,622, filed on Sep. 13, 2021.

(51) Int. Cl. G01V 1/16; E21B 19/14; E21B 49/00

(52) U.S. Cl. CPC G01V 1/164; E21B 19/146; E21B 49/00

(57) ABSTRACT

A system for assessing soil properties comprises a test tool including an elongated housing including a first end and a second end opposite the first end and a sensing section. The sensing section includes a cone penetrometer test (CPT) tool protruding from the first end of the housing; a first seismic sensor housed in the housing and that senses seismic waves, one or more circuits housed in the housing and that process output of the first seismic sensor, memory housed in the housing and coupled to the one or more circuits and that stores data sensed by the sensing section, and a power source housed in the housing and that provides power for the sensing section.

### FIELD

This application claims priority to and the benefit of U.S. Provisional Application No. 63/243,622, filed on Sep. 13, 2021, and U.S. Provisional Application No. 63/399,120, filed on Aug. 18, 2022, the entire contents of each of which are hereby incorporated by reference.

### FIELD

The present technology is generally related to seismic cone penetration test tools and systems including the same.

### BACKGROUND

Cone penetration test (CPT) tools and/or seismic sensors may be used to determine various geotechnical properties of soil for the purpose of aiding the design and construction of structure foundations, earthworks, and other structures. CPT tools and seismic sensors for subsea soil measurements present design challenges due to the tool's/sensor's operation within an underwater environment.

### SUMMARY

Example aspects of the present disclosure include:

A system for assessing soil properties, the system comprising: a test tool including: an elongated housing including a first end and a second end opposite the first end; and a sensing section including: a cone penetrometer test (CPT) tool protruding from the first end of the housing; a first seismic sensor housed in the housing configured to sense seismic waves; one or more circuits housed in the housing configured to process output of the first seismic sensor; memory housed in the housing and coupled to the one or more circuits configured to store data sensed by the sensing section; and a power source housed in the housing configured to provide power for the sensing section. In some implementations, the one or more circuits comprised in the test tool allow for signal processing to take place in the test tool itself. In the same or other implementations, the inclusion of a battery within the test tool allows the test tool to comprise a suitable amount of onboard battery storage to record data for a typical extended deployment of the tool. For example, the inclusion of the battery in the test tool may allow for the test tool to comprise enough onboard storage to record for a typical subsea deployment of the test tool.

Any of the aspects herein, wherein the sensing section further comprises: a communications interface coupled to the one or more circuits and disposed at the second end of the housing. In some implementations, the communications interface allows for communication and/or data transfer between the test tool and a drill, for example a subsea drill, or between the test tool and a subsea or above sea computing device.

Any of the aspects herein, wherein the communications interface comprises a light transceiver, and wherein the second end of the housing comprises an opening through which the light transceiver transmits and receives light.

Any of the aspects herein, wherein the light transceiver comprises a blue light modem.

Any of the aspects herein, further comprising: a drill comprising a carousel from which the test tool is deployed.

Any of the aspects herein, further comprising: at least one seismic source configured to generate the seismic waves sensed by the first seismic sensor.

Any of the aspects herein, wherein the drill comprises a plurality of retractable legs, wherein the at least one seismic source is mounted to at least one retractable leg of the plurality of retractable legs.

Any of the aspects herein, wherein the at least one seismic source comprises a first seismic source configured to generate P-waves and a second seismic source configured to generate S-waves.

Any of the aspects herein, wherein the at least one retractable leg comprises a first retractable leg and a second retractable leg, wherein the first seismic source is mounted on the first retractable leg, and wherein the second seismic source is mounted on the second retractable leg.

Any of the aspects herein, wherein the second seismic source generates S waves that travel in a first direction and S waves that travel in a second direction substantially 180 degrees offset from the first direction.

Any of the aspects herein, wherein the drill comprises a controller configured to control one or more of the first seismic source and the second seismic source based on a seismic wave generation profile.

Any of the aspects herein, wherein the seismic wave generation profile comprises information that governs how many times to activate the at least one seismic source at a given depth of the test tool.

Any of the aspects herein, wherein the sensing section further comprises: a second seismic sensor configured to sense the seismic waves, the second seismic sensor being housed in the housing and spaced apart from the first seismic sensor in a longitudinal direction of the housing.

Any of the aspects herein, wherein the one or more circuits comprises a first clock, and wherein the at least one seismic source is coupled to a second clock synchronized with the first clock. One or more of the first clock and the second clock may be an atomic clock. In some implementations, the first clock and second clock allow for precise timing between the test tool and the seismic source, allowing for accurate recording of the times at which the seismic source is fired on the ocean floor, and of the times at which the seismic waves are detected by the test tool. The accurate timing also allows for implementations wherein the test tool stores all data collected during the time the test tool is in the seabed, and data relating to the trigger signals provided to the seismic source(s), for example the time stamps of such signals, is used to select which of the collected data is of interest.

Any of the aspects herein, wherein the housing comprises a first section, a second section, a third section, and a fourth section, wherein the first section and the second section are detachably connected, the second section and the third section are detachably connected, and the third section and the fourth section are detachably connected.

Any of the aspects herein, wherein the first section comprises the communications interface, and/or the second section comprises the power source, and/or the third section comprises the one or more circuits and the memory, and/or the fourth section comprises the first seismic sensor and the second seismic sensor.

Any of the aspects herein, wherein the first end of the housing from which the CPT tool protrudes is at an end of the fourth section, and wherein the second end of the housing is at an end of the first section.

Any of the aspects herein, wherein the housing is water-tight.

A test tool, comprising: an elongated housing including a first end and a second end opposite the first end; and a sensing section comprising: a cone penetrometer test (CPT) tool protruding from the first end of the housing; a first seismic sensor housed in the housing configured to sense seismic waves; one or more circuits housed in the housing configured to process output of the first seismic sensor; memory housed in the housing and coupled to the one or more circuits configured to store data sensed by the sensing section; and a power source housed in the housing configured to provide power for the sensing section.

A test tool, comprising: an elongated housing including a first section, a second section, a third section, and a fourth section, wherein the first section and the second section are detachably connected, the second section and the third section are detachably connected, and the third section and the fourth section are detachably connected; and a sensing section including: a cone penetrometer test (CPT) tool protruding from the fourth section; first and second seismic sensors housed in the fourth section and that sense seismic waves, wherein the first and second seismic sensors are spaced apart from one another in a longitudinal direction of the fourth section; one or more circuits housed in the third section configured to process output of the first seismic sensor; memory housed in the third section and coupled to the one or more circuits configured to store data sensed by the sensing section; a power source housed in the second section configured to provide power for the sensing section; and a communications interface housed in the first section and coupled to the one or more circuits, the communications interface configured to wirelessly communicate with a corresponding communications interface on a drill that deploys the test tool.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

It is to be appreciated that any feature described herein can be claimed in combination with any other feature(s) as described herein, regardless of whether the features come from the same described embodiment.

The details of one or more aspects of the disclosure are set forth in the accompanying drawings and the description below. Other features, objects, and advantages of the techniques described in this disclosure will be apparent from the description and drawings, and from the claims.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (e.g., X₁ and X₂) as well as a combination of elements selected from two or more classes (e.g., Y₁ and Zₒ).

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

Numerous additional features and advantages of the present invention will become apparent to those skilled in the art upon consideration of the embodiment descriptions provided hereinbelow.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 is a block diagram of a system according to at least one embodiment of the present disclosure;

FIG. 2 illustrates various cross-sectional views of the SCPT tool in FIG. 1 according to at least one embodiment of the present disclosure;

FIG. 3 illustrates an example connector for connecting two sections of the SCPT tool of FIGS. 1 and 2 according to at least one embodiment of the present disclosure;

FIG. 4 illustrates an example for mounting seismic sources to a drill according to at least one embodiment of the present disclosure; and

FIG. 5 illustrates a plan view of a drill with legs extended and having a configuration for seismic sources with different mounting locations than that shown in FIG. 4 according to at least one embodiment of the present disclosure.

### DETAILED DESCRIPTION

It should be understood that various aspects disclosed herein may be combined in different combinations than the combinations specifically presented in the description and accompanying drawings. It should also be understood that, depending on the example or embodiment, certain acts or events of any of the processes or methods described herein may be performed in a different sequence, may be added, merged, or left out altogether (e.g., all described acts or events may not be necessary to carry out the techniques). In addition, while certain aspects of this disclosure are described as being performed by a single module or unit for purposes of clarity, it should be understood that the techniques of this disclosure may be performed by a combination of units or modules associated with, for example, a computing device and/or a medical device.

In one or more examples, the described methods, processes, and techniques may be implemented in hardware, software, firmware, or any combination thereof. If implemented in software, the functions may be stored as one or more instructions or code on a computer-readable medium and executed by a hardware-based processing unit. Computer-readable media may include non-transitory computer-readable media, which corresponds to a tangible medium such as data storage media or memory (e.g., RAM, ROM, EEPROM, flash memory, or any other medium that can be used to store desired program code in the form of instructions or data structures and that can be accessed by a computer).

Instructions may be executed by one or more processors, such as one or more digital signal processors (DSPs), general purpose microprocessors (e.g., Intel Core i3, i5, i7, or i9 processors; Intel Celeron processors; Intel Xeon processors; Intel Pentium processors; AMD Ryzen processors; AMD Athlon processors; AMD Phenom processors; Apple A10 or 10X Fusion processors; Apple A11, A12, A12X, A12Z, or A13 Bionic processors; or any other general purpose microprocessors), application specific integrated circuits (ASICs), field programmable logic arrays (FPGAs), or other equivalent integrated or discrete logic circuitry. Accordingly, the term “processor” as used herein may refer to any of the foregoing structure or any other physical structure suitable for implementation of the described techniques. Also, the techniques could be fully implemented in one or more circuits or logic elements.

Before any embodiments of the disclosure are explained in detail, it is to be understood that the disclosure is not limited in its application to the details of construction and the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the present disclosure may use examples to illustrate one or more aspects thereof. Unless explicitly stated otherwise, the use or listing of one or more examples (which may be denoted by “for example,” “by way of example,” “e.g.,” “such as,” or similar language) is not intended to and does not limit the scope of the present disclosure.

Inventive concepts are directed to seismic cone penetration test tools and systems (e.g., drills) including the same. In particular, some implementations of the present disclosure are directed towards subsea or partially subsea cone penetration test tools and systems. A seismic cone penetration test (SCPT) combines the CPT tool with seismic wave velocity measurements, which may be useful for assessing strain shear modulus and/or soil liquefaction potential index. The basic principle is that a seismic source produces shear waves and compression waves at a horizontal and vertical offset from one or more seismic sensors (e.g., a geophone or accelerometer) in a downhole SCPT tool located in the soil or under the seabed. The detected waveform is captured by the one or more seismic sensors and the data is analyzed to filter out background noise and to compensate for diminishing signal strength. The primary task of the data analysis is to identify the time difference between when the seismic waves were generated by the seismic source and when the waves were sensed by the seismic sensor(s), which informs on various soil properties. Two standards relevant to SCPT are ISO 19901-8 and ASTM D7400.

Notable features of an SCPT tool (also called a downhole tool) according to inventive concepts include, but are not limited to: signal processing in the downhole tool itself, enough onboard battery storage on the downhole tool to record for a typical extended deployment (e.g., if there is drilling trouble), precise timing between the drill and the downhole tool to accurately record when the seismic source fired on the ocean floor and when the seismic waves are detected, record everything when the downhole tool is in the seabed and then use the trigger signal time stamps to select which data of interest, a high dynamic range analog to digital converter (ADC) in the downhole tool to reduce the need for an operator to choose the right gain settings (if the user sets the gain wrong, they could overload the sensor or not resolve the signal from noise), automating the firing of the seismic sources to drastically reduce operation time, and/or using an optical modem on the downhole tool and the drill to communicate and transfer data while the drill is still subsea.

To accomplish the above-mentioned advantages/features and other advantages/features, inventive concepts propose a custom downhole tool with dual array of seismic sensors (e.g., geophones) coupled with a CPT nose cone. The SCPT tool includes one or more batteries for power and memory card for on tool data storage. To enable data validation while the drill that pushes the SCPT tool is submerged, a blue-light modem is incorporated for data upload when, for example, the tool is in the drill carousel between pushes. The blue light modem or other suitable communication interface is integrated with the SCPT tool and the main drill carousel in such a way that when the SCPT tool is in a specific slot in the carousel, the tool is capable of making a serial data connection with the topside (above sea surface) computers. Once connected, data can be transmitted via serial protocol. In addition, when the connection is made, the drill and/or the SCPT tool are sent time synchronization data from a topside Network Time Protocol (NTP) server to ensure that time on the SCPT tool matches time at the drill. In implementations where the system is subsea or partially subsea, the SCPT tool is located subsea, and can be located on or in the seabed.

The seismic source (e.g., a pulse generator) that generates seismic waves for detection by the SCPT tool may be connected to and deployed by the outrigger legs of the drill to ensure decoupling of the trigger from the drill structure. The seismic source may be coupled to the outrigger legs via rubber mounts so that when the drill is on the seabed, the seismic source also rests on the seabed at a predetermined distance away from the hole created for the SCPT tool and at a predetermined distance away from the drill legs and/or drill frame. However, inventive concepts are not limited mounting the seismic source(s) to the drill legs, and the seismic source(s) may be mounted to some other part of the drill or exist as a separate device not tethered to the drill. The seismic source or seismic sources may produce compression waves (P-waves) and shear waves (e.g., left and right S-waves). A topside console (e.g., on a surface vessel) may include control software for the seismic source(s) and may receive the seismic and depth data from the drill for post-processing.

Various implementations of a system according to inventive concepts will now be described. In general, there are at least two methods for communicating data. The CPT data is transmitted via an acoustic transmitter and the seismic data may be transmitted via blue light (or other suitable wireless communication used in underwater environments). The blue light may be emitted from the side of the tool or out of the end through a threaded section. The tool may comprise an electronics section that contains a microcontroller and is responsible for storing data, starting recording and handling data transfer between the topside and the tool. The electronics include the ability to sense when seismic data recording is required. For example, the electronics may sense if the tool is moving or listen for a trigger signal from the drill platform.

The tool may include a section that contains the batteries and a battery management system for the tool. This section will distribute power to the electronics and other components. This section may include a power off switch in the form of a magnetic read switch such that when in a specific slot on the carousel of the drill the power is switched off to the unit.

The tool may comprise a section with dual seismic sensors, such as two geophones as high quality tri-axial analogue devices, or two tri-axial accelerometers to record of S-waves and P-waves. A spacer, whose length is configurable (i.e., dynamically changeable), may be placed between the sensors CPT probe and sound transmitter. A CPT probe is integrated at the bottom of the tool, which has constant communication with the topside via acoustic sound transition through the drill tool structure.

Each section of the tool may be mechanically connected to one another with male/female threaded sections and with an O-ring groove or similar mechanical device to form a pressure barrier between two sections. Other types of mechanical connections are possible such as a friction fit connection, detent connection, and/or the like. The types of electrical connections between components may vary depending on each section as data and power is passed to components. In general, the electrical connections may be integrated with sections of the tool and/or separate from the sections of the tool. An example of integrated electrical connections may include conductive layers built into the sections of the tool (e.g., conductive material built into a layer or inner surface of the cylindrical parts of the tool). In at least one example, the electrical connections are built into the sections of the tool such that mechanically connecting two sections to one another naturally results in electrical connection between components of the two sections. An example of electrical connections that are not integrated with sections of the tool (i.e., connections that are separate from the sections of the tool) may include wiring and/or connectors housed within each section (but not integrated with) that are connected to one another during assembly of the tool.

The system may further comprise a drill that houses and pushes the SCPT tool. In implementations wherein the SCPT tool is subsea, the drill may also be located subsea. In some implementations, the drill rests on the seabed. The drill has existing electronics canisters and where possible these are utilized to handle any extra communication electronics and/or software needed to support the communication of data and control of the SCPT downhole tool.

The drill may include a blue light interface with suitable hardware and/or software for communicating according to suitable visible light communication techniques and/or protocols. The downhole tool may include a transmitter while the drill includes a receiver, but it should be understood that the downhole tool may also include a receiver and the drill may also include a transmitter. In other words, both the drill and the downhole tool may include a blue light transceiver. The blue light transceiver of the drill may be located on the frame of the drill separated from the movement of the carousel. Provided the downhole tool is located in or movable to a specific carousel location within the drill, the drill can align the two blue light transceivers to enable a communication link. In at least one example, the blue light transceivers may employ transmitters with blue LEDs that are pulsed or modulated according to data signals and/or control signals by the electronics section. Additionally, the blue light transceivers may employ receivers that include photodetectors that detect the light emitted from a transmitter and processing circuitry that recovers the data signals and/or control signals from signals generated by the photodetectors.

The system may further include one or more seismic sources, such as a bang box mechanically and electrically connected to the drill and that includes hardware and/or software for generating seismic waves (e.g., p-waves and s-waves).

A system according to inventive concepts that includes the above features and more is described in additional detail below with reference to the figures.

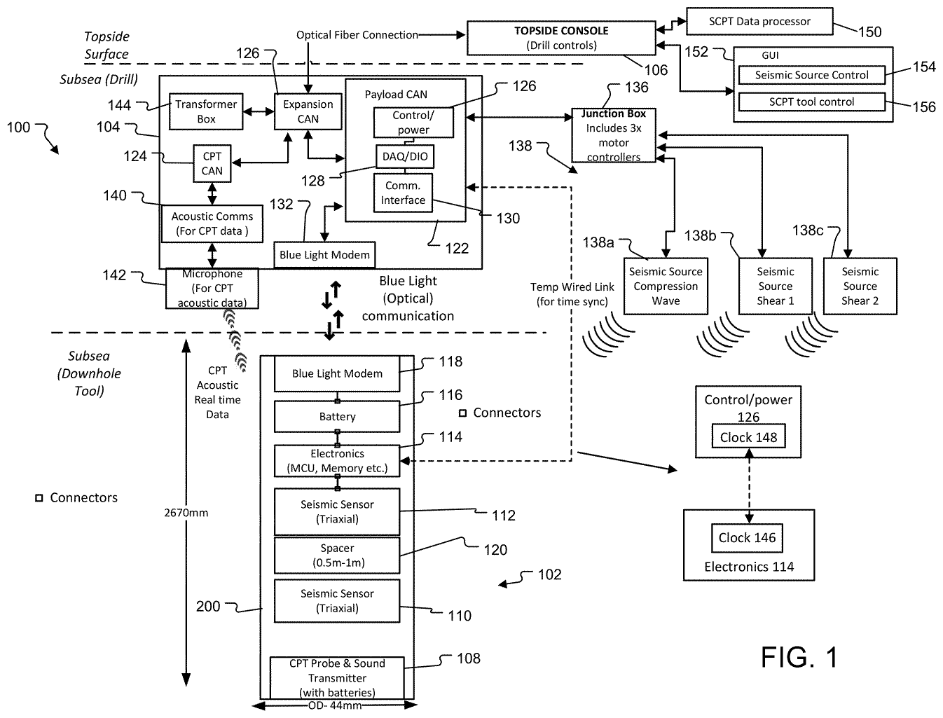

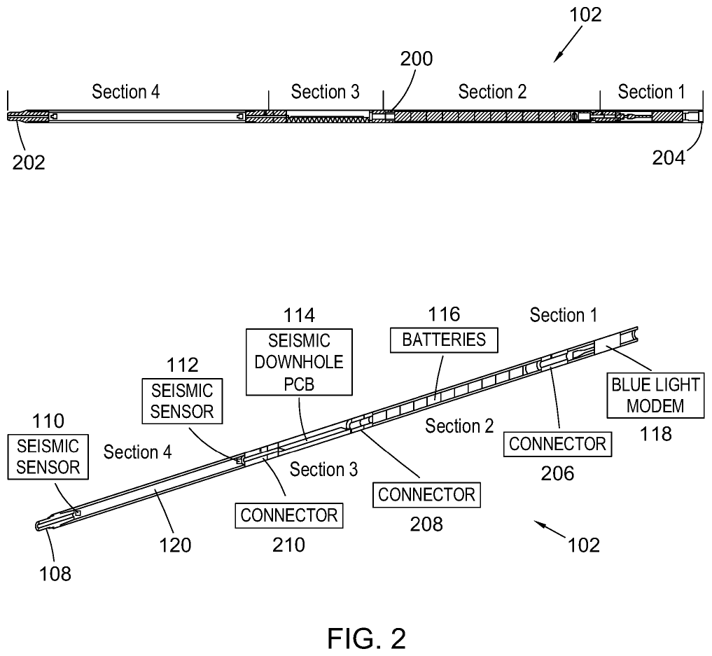

FIG. 1 illustrates a block diagram of a system 100 according to at least one example embodiment. The system 100 includes one or more SCPT tools (or test tools) 102, a drill 104 for pushing the SCPT tool 102 into a surface (e.g., a subsea surface), and a topside console 106 in communication with the drill 104 and located above the sea surface, for example, on a surface vessel that deploys the drill 104. FIG. 2 illustrates various cross-sectional views of the SCPT tool 102. FIGS. 1 and 2 are discussed in more detail below.

With reference to FIGS. 1 and 2, the SCPT tool 102 may include an elongated housing 200 with a first end 202 and a second end 204 opposite the first end 202. In one non-limiting example, the housing 200 is cylindrical and is about 2670 mm long with a diameter of about 44 mm. However, example embodiments are not limited thereto, and the housing 200 may have other sizes and shapes depending on design preferences (e.g., depending on drill carousel size).

The SCPT tool, also referred to herein as a test tool 102 includes a CPT tool or CPT probe 108 protruding from the first end 202 of the housing 200, a first seismic sensor 110 housed in the housing 200, the first seismic sensor configured to sense seismic waves. The SCPT tool can further comprise a second seismic sensor 112 housed in the housing 200, the second seismic sensor configured to sense seismic waves. The SCPT tool 102 may further include one or more circuits embodied as electronics 114 housed in the housing 200, the one or more circuits configured to process output of one or more of the seismic sensors 110 and 112. The SCPT further comprises a power source, for example a battery 116, housed in the housing 200, the power source configured to provide power for components of the SCPT tool 102. The SCPT tool 102 optionally includes a communications interface, for example a light transceiver. The light transceiver may optionally comprise a blue light modem 118. The communications interface is coupled to the electronics 114 and disposed at the second end 204 of the housing. Still further, the SCPT tool 102 may include an optional spacer 120 between the seismic sensors 110 and 112.

The collection of components 108, 110, 112, 114, 116, and 118 may be completely or at least partially housed within the housing 202 and may be collectively referred to as a sensing section. As shown in FIG. 2, the sensing section may include detachably connected sections 1, 2, 3, and 4. Section 1 may comprise a communications interface (e.g., the blue light modem 118), section 2 may comprise a power source, such as the battery 116, section 3 may comprise the one or more circuits and memory included in electronics 114, and section 4 may comprise one or more of the first seismic sensor 110 and the second seismic sensor 112. The memory included in electronics 114 is housed in the housing and coupled to the one or more circuits, and is configured to store data sensed by the sensing section. In other words, the memory may be configured to store data output by the one or more circuits and/or output by one or more of the seismic sensors. The first end 202 of the housing 200 from which the CPT tool 108 protrudes is at an end of section 4 while the second end 202 of the housing 200 is at an end of section 1.

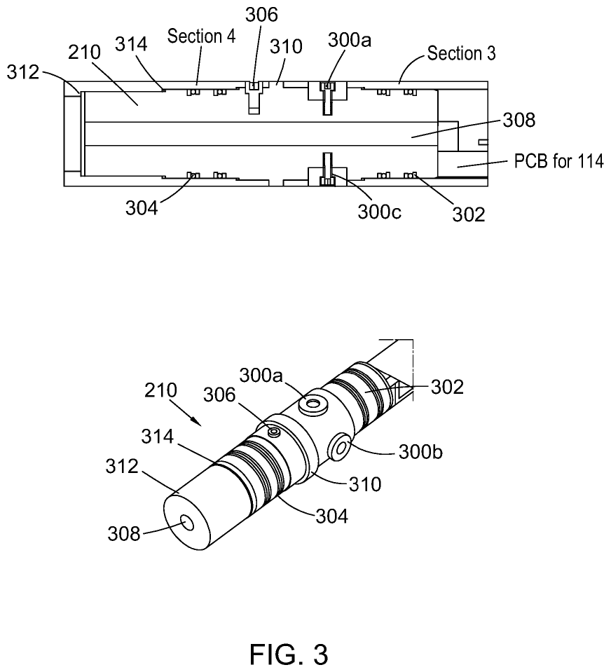

As shown, section 1 and section 2 may be detachably connected by connector 206, section 2 and section 3 may be detachably connected by connector 208, and section 3 and section 4 may be detachably connected by connector 210. The connectors 206, 208, 210 and the housing 200, when assembled together, form a water-tight structure so as to protect the components housed in the housing 200 from the external environment. An example connector is illustrated and discussed in more detail with reference to FIG. 3.

Still with reference to FIGS. 1 and 2, the CPT tool 108 may comprise components suitable for performing cone penetrometer tests, which may include but are not limited to a cone, a load cell, a friction sleeve, a vacuum sensor, an acoustic transmitter, and/or other components to measure sound, force, friction, and/or other parameters useful for cone penetrometer tests. Here, it should be appreciated that, in some embodiments, the CPT tool 108 may be excluded from the system 100 or be included but not used. In this case, the tool 102 is exclusively for seismic measurements with one or more seismic sensors.

The seismic sensors 110 and 112 may each comprise a triaxial geophone, a triaxial accelerometer, and/or other device capable of sensing seismic waves. Each seismic sensor 110 and 112 may be an IEPE (integrated electronics piezo-electric) sensor with built-in electronics that convert a raw signal to a signal suitable for transmission to electronics 114. Although example embodiments are described with respect to a SCPT tool 102 that includes two seismic sensors 110 and 112, more or fewer seismic sensors may be included (e.g., one seismic sensor or three seismic sensors).

The electronics 114 may include suitable hardware and/or software for controlling components of the SCPT tool 102 and/or for processing data from the seismic sensors 110 and 112. The electronics 114 may be mounted on a printed circuit board (PCB) secured within the housing 200. The electronics 114 may comprise one or more circuits, such as a microcontroller unit (MCU), a processor, a microprocessor, or other processing circuit. The electronics 114 may comprise memory (e.g., volatile memory, non-volatile memory) coupled to the one or more circuits and that stores data (e.g., sensed by the sensing section) and/or instructions that are executed by a processor of the one or more circuits to control functionality of the SCPT tool 102. The electronics 114 may further include a high dynamic range analog to digital converter (ADC) for converting analog signals from the seismic sensors 110 and 112 into digital data for storage by the memory. In some implementations, the high dynamic range analog to digital converter in the downhole tool reduces the need for an operator to choose the right gain settings. In a conventional system, the gain settings are chosen manually, and if the wrong gain settings are chosen by the operator, they may overload the sensor, or they may not be able to resolve the signal from the noise (i.e. they will not capture any data). As the downhole tool may be deployed subsea for relatively long periods of time, it is desirable to have a more effective way of ensuring data capture while the test tool is deployed. Having a high dynamic range analog to digital converter allows for more effective capture of data from the downhole tool, as it reduces the need for an operator to choose the right gain settings in order to capture data. In at least one example, the digital signals are used to control output of the blue light modem 118 to communicate data to the topside surface through the drill 104. As may be appreciated, the SCPT tool 102 communicates data in at least two ways: the CPT data is transmitted via an acoustic transmitter of the CPT tool 108, and the seismic data is transmitted via the blue light modem 118 that emits from the side of the SCPT tool 102 or out of the second end 204 of the SCPT tool 102 (shown in FIG. 1 as emitting light from end 204 of the tool).

The battery 116 may comprise a suitable power source for providing power to components of the SCPT tool 102 (e.g., the modem 118, electronics 114, the seismic sensors 110, 112). The battery 116 may be rechargeable or not rechargeable in nature. The battery 116 may comprise multiple batteries connected in series or parallel with one another. In at least one non-limiting example, the battery 116 comprises a set of D-cell batteries (e.g., 8 batteries) connected in series.

The light transceiver may comprise, or be, a visible light model such as a blue light modem 118. In at least one example, the second end 204 of the housing comprises an opening through which the light transceiver transmits and receives light. Although not explicitly shown, it should be appreciated that such a light transceiver may include a light source for emitting light (e.g., a light-emitting diode LED that emits blue light) and a light detector for detecting light (e.g., a photodiode or an array of photodiodes). The light source of the blue light modem 118 and/or a light detector may at least partially be located within a flooded portion of the SCPT tool 102, where the flooded portion is sealed off from the remaining part of the housing 200.

The spacer 120 may be from about 0.5 m to about 1 m or longer in length, depending on a desired spacing between seismic sensors 110 and 112. The spacer 120 may comprise a suitable material, such as steel or other rigid material capable of withstanding the push-pull forces of the drill 104, and may be at least partially hollow or solid throughout. The seismic sensors 110 and 112 may be located at or attached to opposing ends of the spacer 120. In at least one embodiment, a length of the spacer 120 is adjustable (e.g., at the topside) to thereby vary the distance between the seismic sensors 110 and 112. In some examples, the spacer 120 is merely empty air space (i.e., an air cavity) in section 4 of the housing 200 between seismic sensors 110 and 112.

Although FIGS. 1 and 2 illustrate the components of the SCPT tool 102 as being in a particular order within the tool, it should be appreciated that the order of components 110, 112, 114, 116, and 120 can be rearranged within the tool 102 so long as the CPT tool 108 is at one end and the blue light modem 118 is at the opposite end.

In general, the drill 104 comprises various controller area networks (CANs) for controlling different aspects of the drill 104. For example, the drill 104 includes a payload CAN 122, a CPT CAN 124, and an expansion CAN 126.

The payload CAN comprises a control/power block 126, a data acquisition (DAQ) and digital input/output (DIO) device 128, and a communications interface 130. The control/power block 126 may include hardware and/or software for controlling and providing power to other components, such as the DAQ/DIO device 128, a blue light modem 132 of the drill 104, and components of at least one seismic source 138 such as a junction box 136 connected to compression wave source 138a and shear wave sources 138b and 138c. The control/power block 126 may also process data, such as seismic data from the SCPT tool 102 received through the blue light modem 132. The DAQ/DIO device 128 may comprise suitable hardware and/or software for processing and/or relaying data and control signals between the expansion CAN 126 and the control/power block 126. The communications interface 130 comprises suitable hardware and/or software for translating and/or processing signals passed between the DAQ/DIO device 128 and the blue light modem 132. Here, it should be appreciated that although example embodiments are described with respect to blue light communication between the SCPT tool 102 and the drill 104, other wireless communication interfaces suitable for underwater environments may be used.

The CPT CAN 124 includes suitable hardware and/or software for collecting and/or processing CPT data received by a microphone 142 of the drill 104 through an acoustic communications interface 140. As noted above, CPT tool 108 comprises a sound transmitter that emits acoustic signals during deployment of the tool 108, which are then detected by the microphone 142 as CPT data to be received and processed by the CPT CAN 124. Thus, the microphone 142 may include any suitable microphone for detecting underwater acoustic signals from the CPT tool 108.

The expansion CAN 126 includes suitable hardware and/or software for processing and/or translating signals passed between components of the drill 104 (e.g., the payload CAN 122 and CPT CAN 124) and the topside console 106. As shown, the connection between the expansion CAN 126 and the topside console 106 may comprise a fiber optic connection. In general, the communication between components of the drill 104 and components attached to the drill 104 (e.g., the seismic source 138) is electrical in nature, and occurs over various Ethernet connections. The expansion CAN 126, thus, may convert electrical signals from the payload CAN 122 and the CPT CAN 124 into optical signals for transmission to the topside console 106. The expansion CAN 126 may also convert optical signals from the topside console 106 to electrical signals for transmission to the payload CAN 122. The expansion CAN 126 may be further coupled to a transformer box 144 that includes electronic components for distributing power to components of the drill 104. The expansion CAN 126 may also serve as a component that enables a user to expand the functionality of the drill 104 to perform other tasks.

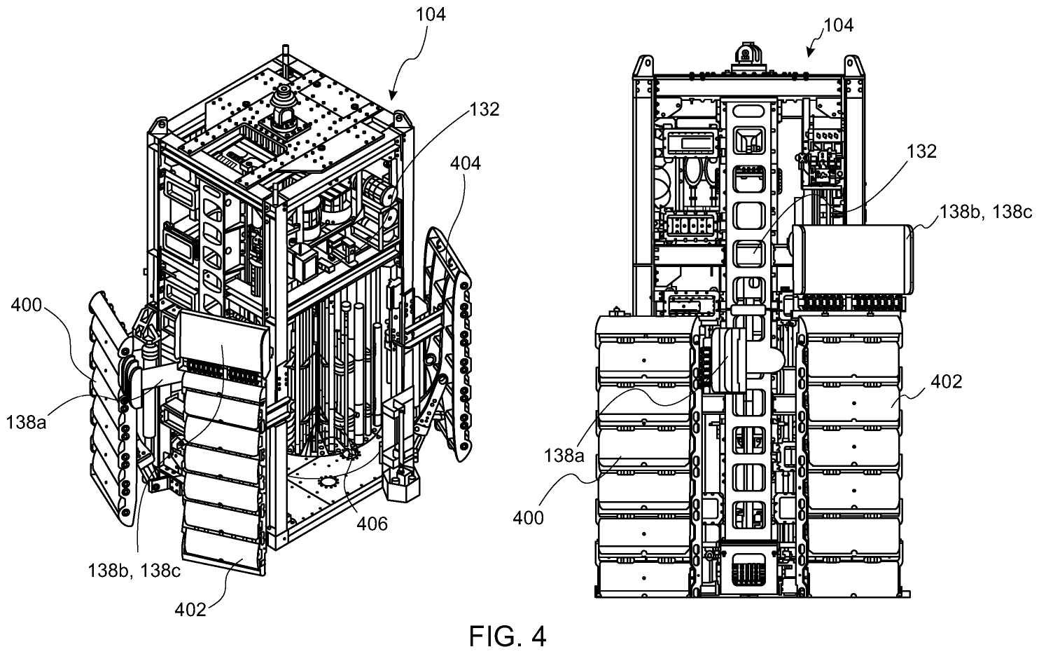

Although not explicitly shown in FIG. 1, the drill 104 may comprise a carousel (from which the SCPT tool 102 is deployed (see FIG. 4).

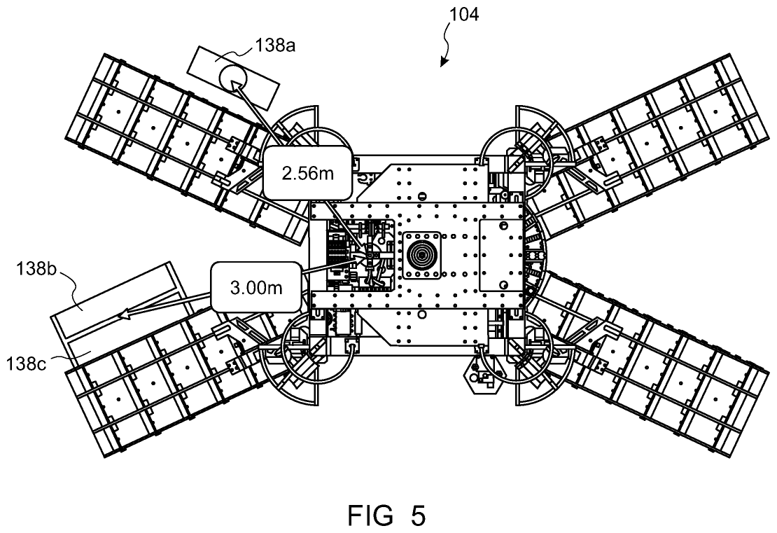

The at least one seismic source 138 generates the seismic waves sensed by the seismic sensors 110 and 112 under control of controllers in junction box 136. In other words, the at least one seismic source is configured to generate the seismic waves sensed by the first sensor As alluded to above, the at least one seismic source 138 comprises a first seismic source 138a that generates P-waves and a second seismic source that generates S-waves. The second seismic source may include two seismic sources 138b and 138c that generate S-waves that travel in opposite directions. For example, the seismic source 138b generates S-waves that travel in a first direction while seismic source 138c generates S-waves that travel in a second direction substantially 180 degrees offset from the first direction. In one example, the first direction corresponds to a horizontal left direction while the second direction corresponds to a horizontal right direction. The junction box 136 and seismic sources 138a, 138b, and 138c may be integrated into a same housing or may exist in independent housings. In at least one example, one or more of the seismic sources 138 are attached to outrigger legs of the drill 104 (see FIGS. 4 and 5). In one specific non-limiting example, seismic source 138a is attached to one outrigger leg while the sources 138b and 138c are attached to a different outrigger leg. Each seismic source 138a,b,c may include its own motor controlled by a corresponding motor controller of the junction box 136. In other examples, each seismic source 138a,b,c comprises hydraulics that are operated to cause seismic waves. The junction box 136 may be included within the drill 104 (e.g., in the payload CAN 122) and/or within a housing that includes one or more of the sources 138a, 138b, 138c.

Seismic data collection may vary depending on the depth of the tool and type(s) of soil between the seismic source and the seismic sensors. For this reason, related art seismic sources for above ground tools are activated manually based on user input to a controller at the topside surface until useful seismic data is collected. However, the SCPT tool 102 is not in communication with the drill 104 while in the borehole. Thus, in at least one example embodiment, the control/power block 126 and/or the junction box 136 is programmed to automatically control the seismic source 138 based on a seismic wave generation profile. That is to say, the control/power block 126 and/or the junction box 136, also referred to herein as a controller, controls one or more of the first seismic source and the second seismic source based on a seismic wave generation profile. The seismic wave generation profile may include information that governs how many times and when to activate the individual seismic sources 138a, 138b, and 138c at a given depth of the SCPT tool 102 with the goal of producing high quality seismic data. In at least one example embodiment, the seismic wave generation profile is based on historical information collected from other SCPT surveys that correlate the quality of seismic data with a depth of the SCPT tool 102, anticipated soil characteristics, and/or the number, frequency, and/or type of seismic waves. Stated another way, the seismic wave generation profile may be implemented to automatically cause the firing of the seismic sources 138a, b, c in manner that is predicted to result in high quality seismic data collected by the SCPT tool 102 given the results from previous surveys or other knowledge (high quality data may include seismic recordings that achieve a maximum or improved signal-to-noise ratio). In some implementations, automating the firing of the seismic sources can reduce operation time, as there is no longer a need for time-consuming decisions regarding the firing time of the seismic sources to be made by an operator. In at least one embodiment, an initial seismic wave generation profile is implemented at the beginning of a survey but may be dynamically adjusted as a survey progresses to account for factors that vary during the survey. In some implementations, the seismic wave generation profile comprises information that governs the number of activations of the at least one seismic source suitable for a given depth of the test tool. In some implementations, the seismic wave generation profile comprises information that governs the optimal number of activations of the at least one seismic source suitable for a given depth of the test tool.

FIG. 1 further illustrates a temporary wired connection between the payload CAN 122 and the electronics 114, which is used to synchronize clocks of the drill 104 and the SCPT tool 102 prior to deployment of the drill 104 from the topside surface. The wired connection is removed before deployment from the topside surface. In general, timing accuracy is useful for recording P-wave seismic data given the higher velocity of P-waves compared to S-waves. In particular, accurate timing is useful between the seismic tool data collected by sensors 110 and 112 and the seismic trigger data which is generated upon firing of the at least one seismic source 138. Because the SCPT tool 102 and the drill 104 do not typically communicate during the survey, each device comprises independent clocks 146 and 148 within, for example, the electronics 114 and control/power block 126, respectively. In some implementations, the one or more circuits of the SCPT tool comprise a first clock, and at least one seismic source is coupled to a second clock, wherein the second clock is synchronized with the first clock. Each clock 146 and 148 may comprise an oven-controlled crystal oscillator (OCXO) with an accuracy better than 30 ppb. In some implementations, one or more of each clock 146 and 148 may include anatomic clock, for example a cesium atomic clock. Each clock 146 and 148 may be synchronized with a topside server clock before deployment of the drill 104. Time offsets are synchronized at the start of a survey and any relative changes are measured and communicated at the end of the survey. The seismic data sensed by sensors 110 and 112 and the seismic source trigger signal data that triggers source2 138 are timestamped, which enables accurate matching of sensed seismic data by the sensors 110 and 112 to a particular seismic wave from seismic source 138.

At the start of a survey, when communications are established between the SCPT tool 102 and the drill 104, the time relationships may be quantified through serial communications. At the end of the survey, communications are re-established and the time relationships are again measured through serial communications. Knowing the timing relationship at the start of the survey and the end of the survey enables accurate coordination of data between both the drill 104 and the SCPT tool 102. Both clocks 146 and 148 may be updated to match the topside server time as often as possible to further improve the timing accuracy. To the extent timing accuracy needs to be demonstrated before and after each borehole, this can be achieved by comparing the time on the SCPT tool 102 before the tool leaves the carousel of the drill 104 for the first time and when the tool returns to the carousel at the end of the survey. With this method, the accuracy may be demonstrated every time the tool returns and leaves the carousel to give high confidence in the quality of the data being collected.

Still referring to FIG. 1, the topside surface components of system 100 may include the topside console 106 coupled to an SCPT data processor 150 and a graphical user interface (GUI) 152. The topside console 106 may include hardware and/or software that enables control of the drill 104. For example, the topside console 106 may include a display and one or more user input devices such as a touchscreen, mouse, keyboard, microphone, and/or the like. The SCPT data processor 150 may include hardware and/or software for processing data from the SCPT tool 102 received through the drill 104 or received from the SCPT tool 102 itself once recovered from the seafloor. The GUI 152 may include various software modules executable by a processor and rendered on a display. The software modules may include, but are not limited to a seismic source control module 154 that enables user control over and/or feedback from the seismic source 138 (e.g., via user input of a seismic wave generation profile) and an SCPT tool control module 156 that enables user control over and/or feedback from the SCPT tool 102 (if communicating with the drill through blue light modems 118 and 132).

For example, the GUI 152, through SCPT control module 154, may provide a user with battery status information and available memory details for SCPT tool 102, provide a user with the ability to request selective or complete data from the SCPT tool 102 (based on the seismic trigger pulse timings, provided by the drill 104), and/or provide a user with the ability to select a mode of the SCPT tool 102 (e.g., sleep mode, active mode, or data transfer mode). The GUI 152, through the seismic source control module 156, may enable interfacing to the electronic canister for controlling the seismic source 138, selection of a seismic wave generation profile, selection of a type of wave to generate (P-wave generation, left S-wave generation, or right S-wave generation), selection of the total number of P-waves left S-waves, or right S-waves to be generated, and triggering the generation of waves.

During a typical related-art wired SCPT operation, the geotechnical engineer has constant feedback from the seismic sensors to ensure that the data captured is of good quality. In a wireless SCPT system, such as in system 100, there is no constant feedback, which introduces the possibility that the data collected during the SCPT survey will not be acceptable. Thus, in at least one embodiment, the system 100 performs data quality checks to ensure that the SCPT tool 102 is functioning properly and/or gathering data of acceptable quality. Here, the SCPT tool 102 may be periodically recovered to the drill 104 and pass data to the topside console 106 through the blue light modems 118 and 132. The two main reasons to recover the SCPT tool to the carousel are 1) to improve operating methodology and refine technique by: understanding the number of seismic wave recordings required to achieve the desired signal-to-noise ratio by the process of stacking seismic data; and understanding the appropriate settings of the data processing software running on data processor 150 to ensure good quality data, and 2) to avoid extended data gaps due to technical failure (seismic source, SCPT system, etc.); and to validate the synchronization between the seismic source trigger data and SCPT tool's 102 logged data. The frequency at which the data is checked can be reduced by implementing standard operating procedures. In at least one example, the SCPT tool 102 may be recovered for data quality checking in the following situations: after the first or second test depth of a new borehole to ensure the system is operating correctly; after a change in geology is recorded by the CPT cone—this is typically when settings will need to be changed; after CPT refusal—this is a good opportunity to check the data quality; and/or after 6-10 m of depth depending on confidence in the operating procedure. Once the geology is better understood at a survey site, it is possible to reduce the number of data checks even further to decrease operation time.

Turning now to FIG. 3, which illustrates an example connector for connecting two sections of the SCPT tool 102. Specifically, FIG. 3 illustrates a perspective view and a cross sectional view of an example structure for connector 210 in FIG. 2. As may be appreciated, connector 210 includes four radial pins, three of which are illustrated as 300a, 300b, and 300c. However, more or fewer radial pins 300 may be included (e.g., six radial pins) The radial pins 300 may secure the connector 210 to the section 3 of the housing 200 once threaded onto section 3 with threads 302 that may include gaskets to create a water-tight seal between section 3 and the connector 210. As shown in FIG. 3, a PCB on which the electronics 114 are mounted may be fixed to an end of the connector 210 within section 3 of the housing 200.

The connector 210 further includes at least one radial screw 306 that locks section 4 of the housing 200 to the connector 210 once threaded onto section 4 with threads 304 that may include the same or similar gaskets as threads 302 to create a water-tight seal between section 4 and the connector 210. As may be appreciated, the at least one radial screw 306 is seated in the connector 210. However, more or fewer radial screws 306 may be included.

The connector 210 may further include a through hole 308 that passes through the connector 210 (e.g., at a center of the connector 210). The through hole 308 enables wiring between the electronics 114 and the seismic sensors 110, 112 to pass therethrough.

As may be appreciated, the connector 210 further includes an annular protrusion 310 that abuts sections 3 and 4 of the housing 200 once the connector 210 is secured to each section. A push force from the drill 104 may be absorbed at least in part by the annular protrusion 310 and/or by an end face 312 and/or annular portion 314 of the connector 210. Meanwhile, a pull force from the drill 104 is absorbed at least in part by the pins 300.

Although not explicitly shown, connectors 206 and 208 may have the same or similar structure as connector 210, where threads and a combination of radial pins and at least one radial screw are used to connect respective sections of the housing 200 to one another with each connector including a through hole or other passage that allows conductive wiring to pass therethrough.

FIG. 4 illustrates an example for mounting seismic sources to a drill according to at least one example embodiment.

As shown in FIG. 4, the drill 104 includes retractable outrigger legs and a carousel 406 from which the SCPT tool 102 is deployed. The drill 104 may comprise a plurality of retractable legs, for example four retractable legs, that extend to make contact with the seafloor and retract when the drill 104 is recovered. Three legs 400, 402, and 404 are visible in FIG. 4. As noted above, the at least one seismic source 138 is mounted to at least one retractable leg of the plurality of retractable legs. FIG. 4 shows a non-limiting example where the seismic source 138a is mounted to an outer edge of the leg 400 at an end of the leg furthest away from the drill 104 once the leg 400 is extended. Meanwhile, seismic sources 138b and 138c are mounted to a tip of a neighboring leg 402. Although seismic sources 138b and 138c are shown as being mounted to a leg 402 immediately adjacent to the leg 400 to which the seismic source 138a is mounted, example embodiments are not limited thereto, and the seismic source 138a may be mounted to the unillustrated leg located diagonally to leg 402. In addition, seismic sources 138a, 138b, and 138c may be mounted on separate legs or all mounted on a single leg. However, inventive concepts are not limited mounting the seismic sources 138a,b,c to the drill legs, and the seismic sources 138a,b,c may be mounted to some other part of the drill 104 or exist as a completely separate device not tethered to the drill 104.

Each seismic source 138a,b,c may be mounted to a leg through a suitable mechanical connection, which may include pins, nuts, bolts, springs, etc. Each seismic source 138 may be supported by a base plate that is mounted to a leg of the drill with springs to improve contact with the seafloor when deployed. The mounts may comprise dampening components (e.g., rubber mounts) that attenuate vibration imparted to the drill 104 when firing the seismic sources 138. Notably, the seismic sources 138a, 138b, and 138c should be mounted to a leg or legs such that, when the legs are extended, each seismic source is at least a minimum distance away from the borehole into which the SCPT tool 102 is pushed so that the seismic waves do not interfere with the drill 104, the legs do not interfere with the seismic waves, and/or so that the seismic waves are properly sensed by seismic sensors 110 and 112. As an example, FIG. 5 illustrates a plan view of a drill 104 with legs extended and having a configuration for seismic sources 138 with slightly different mounting locations than that shown in FIG. 4. As shown in FIG. 5, seismic source 138a is 2.56 m away from the borehole while seismic sources 138b and 138c are 3.00 m away from the bore hole. However, the distances from the borehole may be adjusted according to design preferences (e.g., 5 m up to 10 m). In at least one embodiment, each seismic source 138 is connected to a corresponding leg in a manner that enables the seismic source 138 to be moved further away from the leg when the leg is deployed to an extended state. For example, a seismic source 138 may be connected to a rod or other structure that is controlled to or naturally extends when the legs are deployed and retracts when or before the legs are retracted.

FIG. 4 further illustrates an approximate location for the blue light modem 132 as being above the carousel 406. Although not explicitly shown due to the nature of the figure, the blue light modem 132 is aligned with a specific slot of the carousel 406 to enable communication with the SCPT tool 102 when the tool 102 is in the specific slot.

In view of the above, it should be appreciated that example embodiments provide SPCT tools and systems with at least the following features and advantages: signal processing in the downhole tool itself, enough onboard battery storage on the downhole tool to record for a typical extended deployment (e.g., if there is drilling trouble), precise timing between the drill and the downhole tool to accurately record when the seismic source fired on the ocean floor, record everything when the downhole tool is in the seabed and then use the trigger signal time stamps to select which data of interest, a high dynamic range analog to digital converter (ADC) in the downhole tool to reduce the need for an operator to choose the right gain settings (if the user sets the gain wrong they could overload the sensor or not resolve the signal from noise), automating the firing of the seismic sources to drastically reduce operation time, and/or using an optical modem on the downhole tool and the drill to communicate and transfer data while the drill is still subsea.

The foregoing is not intended to limit the disclosure to the form or forms disclosed herein. In the foregoing Detailed Description, for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the foregoing has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A system for assessing soil properties, comprising one or more test tools, wherein a test tool of the one or more test tools includes: an elongated housing including a first end and a second end opposite the first end;
a sensing section including:
a cone penetrometer test (CPT) tool protruding from the first end of the housing,
a first seismic sensor housed in the housing and configured to sense seismic waves,
one or more circuits housed in the housing and configured to process output of the first seismic sensor, and
memory housed in the housing and coupled to the one or more circuits and configured to store data sensed by the sensing section; and
a power source housed in the housing configured to provide power for the sensing section.

2. The system of claim 1, wherein the sensing section further comprises:
a communications interface coupled to the one or more circuits and disposed at the second end of the housing.

3. The system of claim 2, wherein the communications interface comprises a light transceiver, and the second end of the housing comprises an opening through which the light transceiver transmits and receives light.

4. The system of claim 3, wherein the light transceiver comprises a blue light modem.

5. The system of claim 1, further comprising:
a drill comprising a carousel from which the test tool is deployed.

6. The system of claim 1, further comprising:
at least one seismic source configured to generate the seismic waves.

7. The system of claim 6, further comprising a drill comprising a carousel from which the test tool is deployed, wherein the drill comprises a plurality of retractable legs, and wherein the at least one seismic source is mounted to at least one retractable leg of the plurality of retractable legs.

8. The system of claim 6, wherein the at least one seismic source comprises a first seismic source configured to generate P-waves and a second seismic source configured to generate S-waves.

9. The system of claim 7, wherein the at least one seismic source comprises a first seismic source configured to generate P-waves and a second seismic source configured to generate S-waves, wherein the at least one retractable leg comprises a first retractable leg and a second retractable leg, wherein the first seismic source is mounted on the first retractable leg, and wherein the second seismic source is mounted on the second retractable leg.

10. The system of claim 8, wherein the second seismic source generates S waves that travel in a first direction and S waves that travel in a second direction substantially 180 degrees offset from the first direction.

11. The system of claim 9, wherein the drill comprises a controller configured to control one or more of the first seismic source and the second seismic source based on a seismic wave generation profile.

12. The system of claim 11, wherein the seismic wave generation profile comprises information that governs how many times to activate the at least one seismic source at a given depth of the test tool.

13. The system of claim 1, wherein the sensing section further comprises:
a second seismic sensor configured to sense the seismic waves, the second seismic sensor being housed in the housing and spaced apart from the first seismic sensor in a longitudinal direction of the housing.

14. The system of claim 6, wherein the one or more circuits comprises a first clock, and wherein the at least one seismic source is coupled to a second clock synchronized with the first clock.

15. The system of claim 14, wherein one or more of the first clock and the second clock comprises an atomic clock.

16. The system of claim 1, wherein the housing comprises a first section, a second section, a third section, and a fourth section, wherein the first section and the second section are detachably connected, the second section and the third section are detachably connected, and the third section and the fourth section are detachably connected.

17. The system of claim 2,
wherein the housing comprises a first section, a second section, a third section, and a fourth section, wherein the first section and the second section are detachably connected, the second section and the third section are detachably connected, and the third section and the fourth section are detachably connected;
wherein the sensing section further comprises a second seismic sensor configured to sense the seismic waves, the second seismic sensor being housed in the housing and spaced apart from the first seismic sensor in a longitudinal direction of the housing; and
wherein the first section comprises the communications interface, the second section comprises the power source, the third section comprises the one or more circuits and the memory, or the fourth section comprises the first seismic sensor and the second seismic sensor.

18. The system of claim 17, wherein the first end of the housing from which the CPT tool protrudes is at an end of the fourth section, and wherein the second end of the housing is at an end of the first section.

19. (canceled)

20. A test tool, comprising:
an elongated housing including a first end and a second end opposite the first end;
a sensing section comprising:
a cone penetrometer test (CPT) tool protruding from the first end of the housing,
a first seismic sensor housed in the housing and configured to sense seismic waves,
one or more circuits housed in the housing and configured to process output of the first seismic sensor, and
memory housed in the housing and coupled to the one or more circuits, wherein the memory is configured to store data sensed by the sensing section; and
a power source housed in the housing and configured to provide power for the sensing section.

21. A test tool, comprising:
an elongated housing including a first section, a second section, a third section, and a fourth section, wherein the first section and the second section are detachably connected, the second section and the third section are detachably connected, and the third section and the fourth section are detachably connected; and
a sensing section including:
a cone penetrometer test (CPT) tool protruding from the fourth section;
first and second seismic sensors housed in the fourth section and configured to sense seismic waves, wherein the first and second seismic sensors are spaced apart from one another in a longitudinal direction of the fourth section;
one or more circuits housed in the third section and configured to process output of the first seismic sensor;
memory housed in the third section, coupled to the one or more circuits, and configured to store data sensed by the sensing section; and
a communications interface housed in the first section, coupled to the one or more circuits, and configured to wirelessly communicate with a corresponding communications interface on a drill that deploys the test tool; and
a power source housed in the second section and configured to provide power for the sensing section.
